(19) United States
(12) Patent Application Publication
(10) Pub. No.: US 2023/0059346 A1
(43) Pub. Date: Feb. 23, 2023

(54) ANTENNA APPARATUS

(71) Applicant: SAMSUNG ELECTRO-MECHANICS CO., LTD., Suwon-si (KR)

(72) Inventors: Daeki LIM, Suwon-si (KR); Jeongki RYOO, Suwon-si (KR); Juhyoung PARK, Suwon-si (KR); Woncheol LEE, Suwon-si (KR); Hyungjin LEE, Suwon-si (KR); Sungyong AN, Suwon-si (KR)

(73) Assignee: SAMSUNG ELECTRO-MECHANICS CO., LTD., Suwon-si (KR)

(21) Appl. No.: 17/864,570

(22) Filed: Jul. 14, 2022

(30) Foreign Application Priority Data
Aug. 17, 2021 (KR) 10-2021-0107931

(51) Int. Cl. H01Q 9/04; H01Q 5/40; H01Q 21/28

(52) U.S. Cl. CPC H01Q 9/0421; H01Q 5/40; H01Q 21/28

(57) ABSTRACT

An antenna apparatus is provided. The antenna apparatus includes a ground plane; a first dielectric layer disposed on the ground plane; a second dielectric layer disposed above the first dielectric layer; a feed via which extends through the first dielectric layer; a feed pattern disposed on the first dielectric layer and connected to the feed via; a coupling via which extends through the first dielectric layer; and a patch antenna pattern disposed on the second dielectric layer, wherein the coupling via overlaps, and is spaced apart from, the patch antenna pattern along a first direction from the ground plane toward the patch antenna pattern.

### CROSS-REFERENCE TO RELATED APPLICATIONS

This application claims the benefit under 35 USC § 119(a)of Korean Patent Application No. 10-2021-0107931, filed on Aug. 17, 2021, in the Korean Intellectual Property Office, the entire contents of which is incorporated herein by reference for all purposes.

### BACKGROUND

### 1. Field

The following description relates to an antenna apparatus.

### 2. Description of Related Art

Recently, millimeter wave (mmWave) communication including fifth generation (5G) communication has been implemented in various communication devices. In the example of the fifth generation (5G) communication, a multi-band antenna that transmits and receives radio frequency (RF) signals of multiple bands with one antenna is being implemented.

Additionally, as portable electronic devices have developed, the size of a display screen or display area of the electronic device has increased, and accordingly, the size of a bezel, which is a non-display area in which an antenna is disposed, has reduced, and thus an area of a region in which the antenna can be installed has also reduced.

The above information disclosed in this Background section is only for enhancement of understanding of the background of the described technology, and therefore, it may contain information that does not form the prior art that is already known in this country to a person of ordinary skill in the art.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, an antenna apparatus includes a ground plane; a first dielectric layer disposed on the ground plane; a second dielectric layer disposed above the first dielectric layer; a feed via which extends through the first dielectric layer; a feed pattern, disposed on the first dielectric layer, and connected to the feed via; a coupling via which extends through the first dielectric layer; and a patch antenna pattern disposed on the second dielectric layer, wherein the coupling via overlaps, and is spaced apart from, the patch antenna pattern along a first direction from the ground plane toward the patch antenna pattern.

The coupling via may be connected to the ground plane.

A height of the coupling via measured along the first direction may be substantially equal to a height of the feed via.

A center of the coupling via, a center of the feed via, and a center of an end a predetermined distance from the feed via among opposite ends of the feed pattern may be disposed to form a substantially acute triangle on a plane viewed from a position above the first dielectric layer.

The patch antenna pattern may be disposed on a plane in which a second direction and a third direction perpendicular to the first direction intersect, and the coupling via may be disposed to overlap a first area of the patch antenna pattern that is formed by a first position where a first line passing through a center of the patch antenna pattern and parallel to the third direction is intersected with a first edge adjacent to the feed via among edges of the patch antenna pattern and parallel to the second direction, a second position spaced apart from the first position by a first distance away from the feed via in a direction parallel to the second direction, a third position spaced apart from the first position by a second distance closer to the center of the patch antenna pattern in a direction parallel to the third direction, and a fourth position spaced apart by the first distance in the direction parallel to the second direction and spaced apart by the second distance in the direction parallel to the third direction from the first position.

The first distance may be approximately 0.26 times a first width of the patch antenna pattern measured in a direction passing through the center of the patch antenna pattern and parallel to the second direction.

The second distance may be approximately 0.07 times a second width of the patch antenna pattern measured in a direction passing through the center of the patch antenna pattern and parallel to the third direction.

A third dielectric layer may be disposed between the first dielectric layer and the second dielectric layer.

A dielectric constant of the third dielectric layer may be less than a dielectric constant of the first dielectric layer and a dielectric constant of the second dielectric layer, and the third dielectric layer may be configured to have an adhesive property.

The feed pattern may be disposed between the first dielectric layer and the second dielectric layer.

In a general aspect, an antenna apparatus includes a ground plane which extends in a first direction and a second direction; and a first antenna and a second antenna disposed on the ground plane and spaced apart from each other in the first direction, wherein the first antenna comprises a first feed via, a coupling via connected to the ground plane, and a first patch antenna pattern which overlaps the first feed via and the coupling via in a third direction, and wherein the second antenna comprises a second feed via and a second patch antenna pattern which overlaps the second feed via.

A height of the coupling via measured along the third direction may be substantially equal to a height of the first feed via, and the coupling via may be spaced apart from the first patch antenna pattern.

A feed pattern may be coupled to the first feed via and coupled to the first patch antenna pattern.

The feed pattern may overlap the first patch antenna pattern along the third direction and is spaced apart from the first patch antenna pattern.

A center of the coupling via, a center of the first feed via, and a center of an end a predetermined distance from the first feed via among opposite ends of the feed pattern may be disposed to form a substantially acute triangle on a plane viewed from a position above the first patch antenna pattern.

The coupling via may be disposed to overlap a first area of the first patch antenna pattern that is formed by a first position where a first line passing through a center of the first patch antenna pattern and parallel to the second direction is intersected with a first edge adjacent to the first feed via among edges of the first patch antenna pattern and parallel to the first direction, a second position spaced apart from the first position by a first distance away from the first feed via in a direction parallel to the first direction, a third position spaced apart from the first position by a second distance closer to the center of the first patch antenna pattern in a direction parallel to the second direction, and a fourth position spaced apart by the first distance in the direction parallel to the first direction and spaced apart by the second distance in the direction parallel to the second direction from the first position.

The first distance may be approximately 0.26 times a first width of the first patch antenna pattern measured in a direction passing through the center of the first patch antenna pattern and parallel to the first direction.

The second distance may be approximately 0.07 times a second width of the first patch antenna pattern measured in a direction passing through the center of the patch antenna pattern and parallel to the second direction.

The first antenna may be configured to transmit and receive a radio frequency (RF) signal of a first band, and the second antenna is configured to transmit and receive an RF signal of a second band, and a center frequency of the first band may be lower than a center frequency of the second band.

The first antenna may include a first dielectric layer disposed on the ground plane, a second dielectric layer disposed above the first dielectric layer, and a third dielectric layer disposed between the first dielectric layer and the second dielectric layer, the second antenna may include a fourth dielectric layer disposed on the ground plane, a fifth dielectric layer disposed above the fourth dielectric layer, and a sixth dielectric layer disposed between the fourth dielectric layer and the fifth dielectric layer, a dielectric constant of the third dielectric layer may be less than a dielectric constant of the first dielectric layer and a dielectric constant of the second dielectric layer, and a dielectric constant of the sixth dielectric layer is less than a dielectric constant of the fourth dielectric layer and a dielectric constant of the fifth dielectric layer.

Other features and aspects will be apparent from the following detailed description, the drawings, and the claims.

### BRIEF DESCRIPTION OF DRAWINGS

FIG. 1 illustrates a perspective view of an example antenna apparatus, in accordance with one or more embodiments.

FIG. 2 illustrates a cross-sectional view of the example antenna apparatus of FIG. 1.

FIG. 3 and FIG. 4 each illustrate a top plan view of a portion of the example antenna apparatus of FIG. 1.

FIG. 5 illustrates a top plan view of a portion of the example antenna apparatus of FIG. 1

FIG. 6 illustrates a cross-sectional view of an example antenna apparatus, in accordance with one or more embodiments.

FIG. 7 illustrates a perspective view of an example antenna array, in accordance with one or more embodiments.

FIG. 8 illustrates a schematic diagram of an example electronic device including an example antenna apparatus, in accordance with one or more embodiments.

FIG. 9 illustrates a graph of a result of an experimental example.

FIG. 10 and FIG. 11 each illustrate a result of an experimental example.

FIG. 12 illustrates a top plan view of another experimental example.

FIG. 13 illustrates a graph of a result of another experimental example.

FIG. 14 illustrates a graph of a result of another experimental example.

FIG. 15 illustrates a graph of a result of another experimental example.

FIG. 16 and FIG. 17 each illustrate a graph of a result of another experimental example.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness, noting that omissions of features and their descriptions are also not intended to be admissions of their general knowledge.

To clearly describe the embodiments, parts that are irrelevant to the description are omitted, and like numerals refer to like or similar constituent elements throughout the specification.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Further, since sizes and thicknesses of constituent members shown in the accompanying drawings are arbitrarily given for better understanding and ease of description, the embodiments are not limited to the illustrated sizes and thicknesses. In the drawings, the thicknesses of layers, films, panels, regions, etc., are exaggerated for clarity. In the drawings, for better understanding and ease of description, the thicknesses of some layers and areas are exaggerated.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

The terminology used herein is for the purpose of describing particular examples only, and is not to be used to limit the disclosure. As used herein, the singular forms “a,” “an,” and “the” are intended to include the plural forms as well, unless the context clearly indicates otherwise. As used herein, the term “and/or” includes any one and any combination of any two or more of the associated listed items. As used herein, the terms “include,” “comprise,” and “have” specify the presence of stated features, numbers, operations, elements, components, and/or combinations thereof, but do not preclude the presence or addition of one or more other features, numbers, operations, elements, components, and/or combinations thereof.

Further, in the specification, the phrase “in a plan view” means when an object portion is viewed from above, and the phrase “in a cross-sectional view” means when a cross-section taken by vertically cutting an object portion is viewed from the side.

In addition, terms such as first, second, A, B, (a), (b), and the like may be used herein to describe components. Each of these terminologies is not used to define an essence, order, or sequence of a corresponding component but used merely to distinguish the corresponding component from other component(s).

Unless otherwise defined, all terms, including technical and scientific terms, used herein have the same meaning as commonly understood by one of ordinary skill in the art to which this disclosure pertains and after an understanding of the disclosure of this application. Terms, such as those defined in commonly used dictionaries, are to be interpreted as having a meaning that is consistent with their meaning in the context of the relevant art and the disclosure of this application, and are not to be interpreted in an idealized or overly formal sense unless expressly so defined herein.

Hereinafter, various embodiments and variations will be described in detail with reference to drawings.

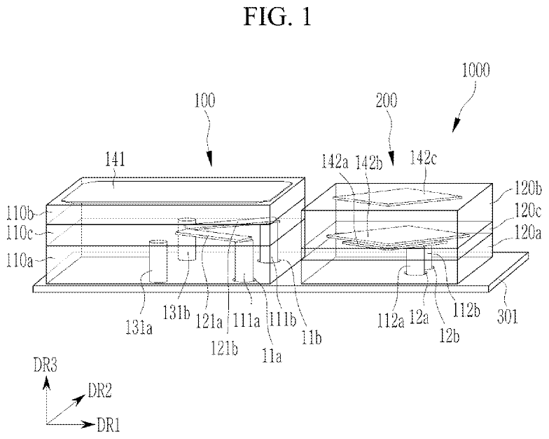

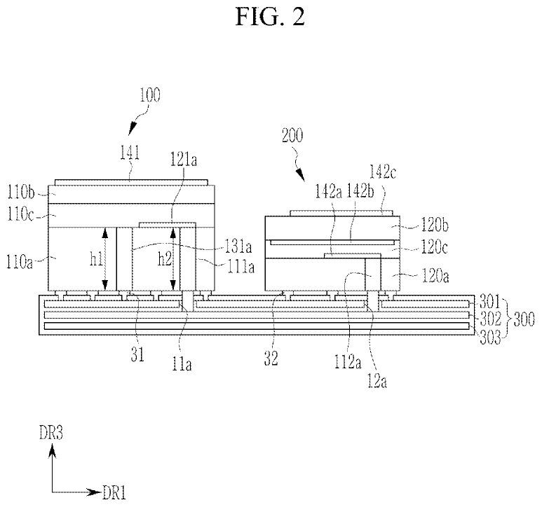

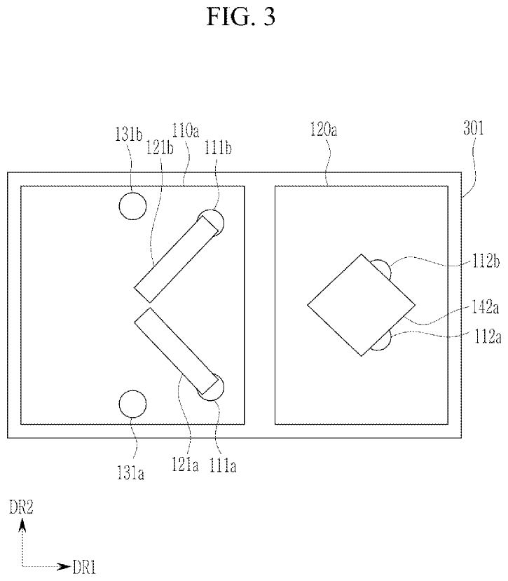

Hereinafter, an example antenna apparatus 1000, in accordance with one or more embodiments, will be described with reference to FIG. 1 to FIG. 3. FIG. 1 illustrates a perspective view of the example antenna apparatus 1000in accordance with one or more embodiments, FIG. 2 illustrates a cross-sectional view of the example antenna apparatus 1000 of FIG. 1, and FIG. 2 and FIG. 3 each illustrate a top plan view of a portion of the example antenna apparatus 1000 of FIG. 1.

The antenna apparatus 1000, in accordance with one or more embodiments, includes a first antenna 100 and a second antenna 200 disposed adjacent to each other in a first direction DR1.

The first antenna 100 may include a first dielectric layer 110a disposed on a ground plane 301, a second dielectric layer 110b disposed on or above the first dielectric layer 110a, a third dielectric layer 110c disposed between the first dielectric layer 110a and the second dielectric layer 110b, a first feed via 111a and a second feed via 111b, a first feed pattern 121a and a second feed pattern 121b, a first coupling via 131a and a second coupling via 131b, and a first patch antenna pattern 141 disposed to overlap the first feed pattern 121a and the second feed pattern 121b and the first coupling via 131a and the second coupling via 131b.

The second antenna 200 may include a fourth dielectric layer 120a disposed on the ground plane 301, a fifth dielectric layer 120b disposed on or above the fourth dielectric layer 120a, a sixth dielectric layer 120c disposed between the fourth dielectric layer 120a and the fifth dielectric layer 120b, a third feed via 112a and a fourth feed via 112b disposed between the fourth dielectric layer 120a and the fifth dielectric layer 120b, a second patch antenna pattern 142a connected to the third feed via 112a and the fourth feed via 112b, a third patch antenna pattern 142b which overlaps the second patch antenna pattern 142a, and a fourth patch antenna pattern 142c which overlaps the third patch antenna pattern 142b.

First, a structure of the first antenna 100 will be described in more detail.

The first antenna 100 may include the first dielectric layer 110a that extends in the first direction DR1 and the second direction DR2, the second dielectric layer 110b disposed on or above the first dielectric layer 110a in the third direction DR3 to extend in the first direction DR1 and the second direction DR2, and the third dielectric layer 110c disposed between the first dielectric layer 110a and the second dielectric layer 110b.

In an example, dielectric constants of the first dielectric layer 110a, the second dielectric layer 110b, and the third dielectric layer 110c may be different, and the dielectric constants of the first dielectric layer 110a and the second dielectric layer 110b may be greater than a dielectric constant of the third dielectric layer 110c. In an example, the first dielectric layer 110a and the second dielectric layer 110b may each include a ceramic-based material such as low temperature co-fired ceramic (LTCC) or a material having a relatively high dielectric constant such as a glass-based material, and may each further contain at least one of magnesium (Mg), silicon (Si), aluminum (Al), calcium (Ca), or titanium (Ti). For example, the third dielectric layer 110c may include a polymer, may include a material having high flexibility such as a liquid crystal polymer (LCP) or a polyimide or an epoxy resin having high strength or high adhesion, or may include Teflon or a prepreg.

In an example, thicknesses of the first dielectric layer 110a, the second dielectric layer 110b, and the third dielectric layer 110c may be different. For example, the thickness of the first dielectric layer 110a may be the greatest, and the thickness of the third dielectric layer 110c may be smaller than thicknesses of the first dielectric layer 110a and the second dielectric layer 110b.

The third dielectric layer 110c may have adherence, and the third dielectric layer 110c may form a dielectric medium boundary interface between the first dielectric layer 110a and the second dielectric layer 110b. Although not illustrated, the third dielectric layer 110c may have an air cavity formed in a center thereof, and the cavity may be filled with air. Accordingly, a dielectric constant of the third dielectric layer 110c may be smaller than a dielectric constant of the first dielectric layer 110a and the second dielectric layer 110b.

Referring to FIG. 3 together with FIG. 1 and FIG. 2, the first feed via 111a and the second feed via 111b of the first antenna 100 may extend through, or penetrate, the first dielectric layer 110a, and may be connected under the ground plane 301 by extending through the ground plane 301 through a first hole 11a and a second hole 11b formed in the ground plane 301

The first feed via 111a and the second feed via 111b may be connected to the first feed pattern 121a and the second feed pattern 121b disposed on the first dielectric layer 110a.

The first coupling via 131a and the second coupling via 131b may be connected to the ground plane 301, and may extend through the first dielectric layer 110a. The first coupling via 131a and the second coupling via 131b may be connected to the ground plane 301 through the first connector 31. The first connector 31 may have a structure such as, but not limited to, a solder ball, a pin, a land, or a pad. The first antenna 100 may be connected to a connecting member 300 through a plurality of first connectors 31 disposed below the first dielectric layer 110a. The connecting member 300 may include the ground plane 301 and a plurality of metal layers 302 and 303.

A first height h1 of the first coupling via 131a and the second coupling via 131b may be substantially equal to a second height h2 of the first feed via 111a and the second feed via 111b along the third direction DR3.

On a plane formed by an intersection of the first direction DR1 and the second direction DR, the first coupling via 131a may be disposed closer to the first feed via 111a than the second feed via 111b, and the second coupling via 131b may be disposed closer to the second feed via 111b than the first feed via 111a.

The first coupling via 131a and the second coupling via 131b are disposed to overlap the first patch antenna pattern 141 in the third direction DR3.

The positions of the first coupling via 131a and the second coupling via 131b will be described in more detail later.

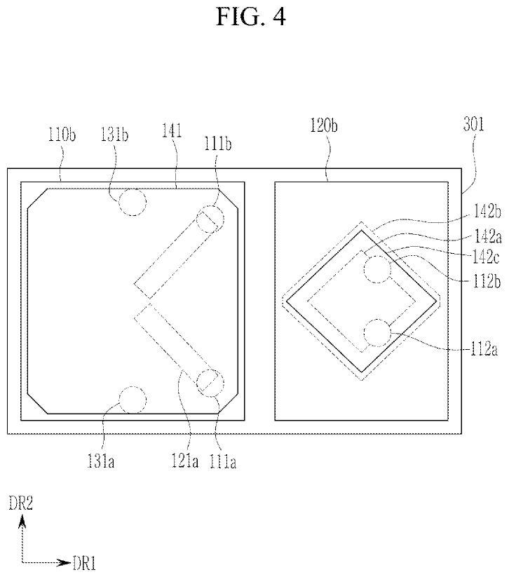

Referring to FIG. 4 together with FIG. 1 and FIG. 2, the first patch antenna pattern 141 disposed on the second dielectric layer 110b of the first antenna 100 may overlap the first feed pattern 121a and the second feed pattern 121b connected to the first feed via 111a and the second feed via 111b in the third direction DR3 to transmit and receive a first RF signal through the first feed via 111a and the second feed via 111b and the first feed pattern 121a and the second feed pattern 121b.

The first feed via 111a and the second feed via 111b may transfer electrical signals having different polarization characteristics, and surface currents flowing through the first patch antenna pattern 141 in response to electrical signals of the first feed via 111a and the second feed via 111b may flow perpendicular to each other.

When an electrical signal is transferred to the first feed via 111a and the second feed via 111b, the electrical signal may be transferred to the first patch antenna pattern 141, and the first patch antenna pattern 141 may transmit and receive an RF signal. Accordingly, the first antenna 100 may transmit and receive a first RF signal of a first bandwidth having different polarization characteristics. The first antenna 100 may transmit and receive a first RF signal of a first polarization through an electrical signal applied by the first feed via 111a, and may transmit and receive a first RF signal of a second polarization through an electrical signal applied by the second feed via 111b. In an example, the first RF signal of the first polarization may have horizontal polarization, and the first RF signal of the second polarization may have vertical polarization.

In this example, the first coupling via 131a may be additionally coupled to the first feed via 111a and the first feed pattern 121a, and the second coupling via 131b may be additionally coupled to the second feed via 111b and the second feed pattern 121b. Accordingly, a gain and a bandwidth of the first antenna 100 may be improved.

In the illustrated embodiment, the first feed pattern 121a and the second feed pattern 121b are illustrated to overlap the first patch antenna pattern 141, but this is an example, and according to another embodiment, the first feed pattern 121a and the second feed pattern 121b may be directly connected to the first patch antenna pattern 141 to transfer an electrical signal. Additionally, in accordance with one or more embodiments, the first antenna 100 may further include an additional parasitic patch antenna pattern in addition to the first patch antenna pattern 141, and the first patch antenna pattern 141 may be additionally coupled to the parasitic patch antenna pattern to improve the gain and the bandwidth of the first antenna 100.

As described above, the first height h1 of the first coupling via 131a and the second coupling via 131b may be substantially the same as the height h2 of the first feed via 111a and the second feed via 111b, to thereby overlap the first patch antenna pattern 141 along the third direction DR3 without being spaced apart from, and in contact with, the first patch antenna pattern 141.

The first coupling via 131a and the second coupling via 131b may be disposed to overlap the first patch antenna pattern 141 along the third direction DR3, to thereby prevent the antenna apparatus from becoming large for the arrangement of the coupling vias unlike an example where the first coupling via 131a and the second coupling via 131b are formed on a side surface of the first patch antenna pattern 141.

Accordingly, in the example antenna apparatus according to the present embodiment, the antenna may be miniaturized while improving performance of the antenna apparatus.

Now, the second antenna 200 will be described in more detail,

The second antenna 200 may include a fourth dielectric layer 120a extending in the first direction DR1 and the second direction DR2, a fifth dielectric layer 120b disposed on the fourth dielectric layer 120a along the third direction DR3 to extend in the first direction DR1 and the second direction DR2, and a sixth dielectric layer 120c disposed between the fourth dielectric layer 120a and the fifth dielectric layer 120b.

In an example, dielectric constants of the fourth dielectric layer 120a, the fifth dielectric layer 120b, and the sixth dielectric layer 120c may be different from each other, and the dielectric constants of the fourth dielectric layer 120a and the fifth dielectric layer 120b may be greater than a dielectric constant of the sixth dielectric layer 120c. In an example, the fourth dielectric layer 120a and the fifth dielectric layer 120b may each include a ceramic-based material such as a low temperature co-fired ceramic (LTCC) or a material having a relatively high dielectric constant such as a glass-based material, and may each further contain at least one of magnesium (Mg), silicon (Si), aluminum (Al), calcium (Ca), or titanium (Ti). In an example, the sixth dielectric layer 120c may include a polymer, may include a material having high flexibility such as a liquid crystal polymer (LCP) or a polyimide, or an epoxy resin having high strength or high adhesion, or may include Teflon or a prepreg.

Thicknesses of the fourth dielectric layer 120a, the fifth dielectric layer 120b, and the sixth dielectric layer 120c may be different from each other. In an example, the thickness of the fifth dielectric layer 120b may be the greatest, and the thickness of the sixth dielectric layer 120c may be smaller than thicknesses of the fourth dielectric layer 120a and the fifth dielectric layer 120b.

The sixth dielectric layer 120c may have adherence, and the sixth dielectric layer 120c may form a dielectric medium boundary interface between the fourth dielectric layer 120a and the fifth dielectric layer 120b.

Referring to FIG. 3 together with FIG. 1 and FIG. 2, the third feed via 112a and the fourth feed via 112b of the first antenna 200 may extend through the fourth dielectric layer 120a, and may be connected under the ground plane 301 by extending through the ground plane 301 through a third hole 12a and a fourth hole 12b formed in the ground plane 301. The second antenna 200 may be connected to the connecting member 300 through a plurality of second connectors 32 disposed below the fourth dielectric layer 120a.

The connecting member 300 may include the ground plane 301 and a plurality of metal layers 302 and 303.

The third feed via 112a and the fourth feed via 112b may be connected to the second patch antenna pattern 142a disposed on the fourth dielectric layer 120a to apply an electrical signal to the second patch antenna pattern 142a.

The third patch antenna pattern 142b disposed between the sixth dielectric layer 120c and the fifth dielectric layer 120b may be coupled to the second patch antenna pattern 142a, and the fourth patch antenna pattern 142c disposed on the fifth dielectric layer 120b may be coupled to the third patch antenna pattern 142b to transmit and receive an electrical signal, so as to allow the second antenna 200 to transmit and receive a second RF signal.

The third feed via 112a and the fourth feed via 112b may transfer electrical signals having different polarization characteristics, surface currents flowing in the second patch antenna pattern 142a, the third patch antenna pattern 142b, and the fourth patch antenna pattern 142c in response to the electrical signals of the third feed via 112a and the fourth feed via 112b may flow perpendicular to each other, and the second antenna 200 may transmit and receive RF signals of a second bandwidth having different polarization characteristics.

The second antenna 200 may transmit and receive a second RF signal of a first polarization through an electrical signal applied by the third feed via 112a, and may transmit and receive a second RF signal of a second polarization through an electrical signal applied by the fourth feed via 112b. In an example, the second RF signal of the first polarization may have horizontal polarization, and the second RF signal of the second polarization may have vertical polarization.

The first antenna 100 may transmit and receive an RF signal of a first bandwidth, and the second antenna 200 may transmit and receive an RF signal of a second bandwidth that is different from the first bandwidth. A center frequency of the first bandwidth may be lower than a center frequency of the second bandwidth. In a non-limited example, the center frequency of the first bandwidth of the first antenna 100 may be about 24 GHz or about 29.5 GHz, and the center frequency of the second bandwidth of the second antenna 200 may be about 39 GHz.

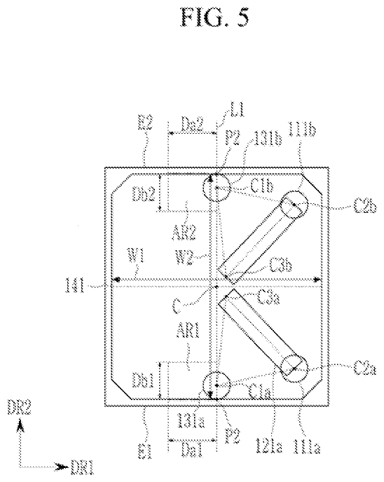

Now, disposal of the first coupling via 131a and the second coupling via 131b of the first antenna 100 will be described in more detail with reference to FIG. 5. FIG. 5 illustrates a top plan view of a portion of the example antenna apparatus 1000 of FIG. 1.

As described above, the first coupling via 131a and the second coupling via 131b are disposed to overlap the first patch antenna pattern 141 in the third direction DR3.

Referring to FIG. 5, the first coupling via 131a may be disposed to overlap a first area AR1 of the first patch antenna pattern 141 in the third direction DR3.

The first area AR1 of the first patch antenna pattern 141 may be formed by connecting a first position P1 where a virtual first line L1 passing through a center C of the first patch antenna pattern 141 and parallel to the second direction DR2 is intersected with a first edge El parallel to the first direction DR1 and adjacent to the first feed via 111a among edges of the first patch antenna pattern 141, a position spaced apart from the first position P1 by a first distance Dal in a direction away from the first feed via 111a along a direction parallel to the first direction DR1, a position spaced apart by a second distance Dbl in a direction closer to the center of the first patch antenna pattern 141 along a direction parallel to the second direction DR2, and a position spaced apart from the first position P1 by the first distance Dal along a direction parallel to the first direction DR1 and spaced apart by the second distance Db1 along a direction parallel to the second direction DR2.

The first distance Dal may be within about 0.26 times a first width W1 of the first patch antenna pattern 141, measured along a direction parallel to the first direction DR1 passing through the center C of the first patch antenna pattern 141, and the second distance Db1 may be within about 0.07 times a second width W2 of the first patch antenna pattern 141, measured along a direction parallel to the second direction DR2 passing through the center C of the first patch antenna pattern 141.

In an example, when the first width W1 of the first patch antenna pattern 141 is about 2.2 mm and the second width W2 of the first patch antenna pattern 141 is about 2.3 mm, the first distance Dal may be within a range of 0 mm to about 5 mm, and the second distance Db1 may be within a range of 0 mm to about 1 mm.

Similarly, the second coupling via 131b may be disposed to overlap a second area AR2 of the first patch antenna pattern 141 in the third direction DR3.

The second area AR2 of the first patch antenna pattern 141 may be formed by connecting a first position P2 where the virtual first line L1 passing through the center C of the first patch antenna pattern 141 and parallel to the second direction DR2 is intersected with a second edge E2 parallel to the first direction DR1 and adjacent to the second feed via 111b among the edges of the first patch antenna pattern 141, a position spaced apart from the second position P2 by a third distance Da2 in a direction away from the first feed via 111a along a direction parallel to the first direction DR1, a position spaced apart from the second position P2 by a fourth distance Db2 in a direction closer to the center of the first patch antenna pattern 141 along a direction parallel to the second direction DR2, and a position spaced apart from the first position P2 by the third distance Da2 along a direction parallel to the first direction DR1 and spaced apart by the fourth distance Db2 along a direction parallel to the second direction DR2.

The third distance Da2 may be within about 0.26 times a first width W1 of the first patch antenna pattern 141, measured along a direction parallel to the first direction DR1 passing through the center C of the first patch antenna pattern 141, and the fourth distance Db2 may be within about 0.07 times a second width W2 of the first patch antenna pattern 141, measured along a direction parallel to the second direction DR2 passing through the center C of the first patch antenna pattern 141.

In an example, when the first width W1 of the first patch antenna pattern 141 is about 2.2 mm and the second width W2 of the first patch antenna pattern 141 is about 2.3 mm, the third distance Da2 may be within a range of 0 mm to about 5 mm, and the fourth distance Db2 may be within a range of 0 mm to about 1 mm.

In a plan view, a center C1a of the first coupling via 131a, a center C2a of the first feed via 111a, and a center C3a of an end a predetermined distance from the first feed via 111a among opposite ends of the first feed pattern 121a may be disposed to form substantially an acute triangle, and a center C1b of the second coupling via 131b, and a center C2b of the second feed via 111b, a center C3b of an end a predetermined distance from the second feed pattern 121b among the opposite ends of the second feed pattern 121b may be disposed to form substantially an acute triangle.

Accordingly, the first coupling via 131a may be additionally coupled to the first feed via 111a to adjust a path of an electromagnetic signal so as to widen a bandwidth of a first RF signal of a first polarization transmitted and received by the first patch antenna pattern 141, and also may be spaced apart from the first feed via 111a and the first feed pattern 121a to form a predetermined distance therebetween, which may not directly affect the electromagnetic signal transmitted to the first feed via 111a and the first feed pattern 121a, thereby preventing deterioration of the first RF signal of the first polarization transmitted and received by the first patch antenna pattern 141.

Similarly, the second coupling via 131b may be additionally coupled to the second feed via 111b to adjust a path of an electromagnetic signal so as to widen a bandwidth of a first RF signal of a second polarization transmitted and received by the first patch antenna pattern 141, and may also be spaced apart from the second feed via 111b and the second feed pattern 121a to form a predetermined distance therebetween, which may not directly affect the electromagnetic signal transmitted to the second feed via 111b and the second feed pattern 121b, thereby preventing deterioration of the first RF signal of the second polarization transmitted and received by the first patch antenna pattern 141.

Additionally, a first gap between a third position overlapping the center C of the first patch antenna pattern 141 and the first coupling via 131a and a second gap between the third position and the second coupling via 131b may be disposed to be substantially equal to each other. Additionally, a gap between the first feed via 111a and the first coupling via 131a and a gap between the second feed via 111b and the second coupling via 131b may be disposed to be substantially equal to each other.

Accordingly, the first coupling via 131a and the second coupling via 131b may be spaced at a same distance from each other based on the center C of the first patch antenna pattern 141 and disposed to form a same distance as the first feed via 111a and the second feed via 111b so as to prevent a radiation pattern of an antenna from being tilted, and the radiation pattern of the antenna is disposed in a fixed position in a reference direction (boresight), so that the radiation pattern may not be changed even when it is included in an antenna array structure including a plurality of antennas.

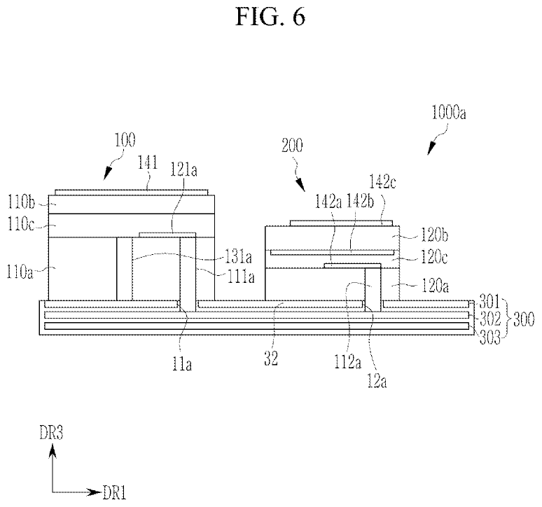

Hereinafter, an antenna apparatus 1000a, in accordance with one or more embodiments, will be described with reference to FIG. 6. FIG. 6 illustrates a cross-sectional view of an example antenna apparatus, in accordance with one or more embodiments.

Referring to FIG. 6, the example antenna apparatus 1000a, in accordance with one or more embodiments, is similar to the antenna apparatus 1000 according to the embodiment described above with reference to FIG. 1 to FIG. 5. A detailed description of same constituent elements will be omitted.

However, unlike the example antenna apparatus 1000 according to the above-described embodiment, the example antenna apparatus 1000a according to the present embodiment may be connected to the connecting member 300 without a plurality of connectors 31 and 32.

As such, the example antenna apparatus 1000a according to the present embodiment may be different from the antenna apparatus 1000 according to the above-described embodiment, and the first antenna 100 and the second antenna 200 may be integrally formed with the connecting member 300 on the connecting member 300.

Many features of the example antenna apparatus 1000, in accordance with one or more embodiments described above with reference to FIG. 1 to FIG. 5 are applicable to the antenna apparatus 1000a according to the present embodiment.

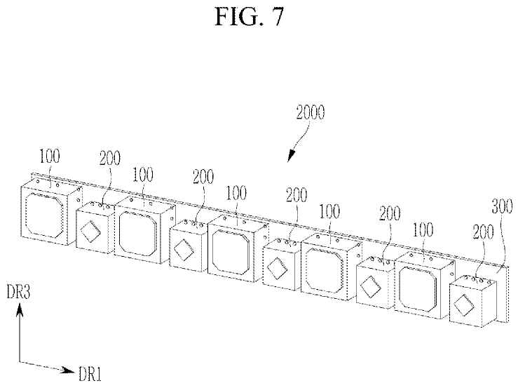

Hereinafter, an antenna array 2000 according to an embodiment will be described with reference to FIG. 7. FIG. 7 illustrates a perspective view of the example antenna array 2000, in accordance with one or more embodiments.

Referring to FIG. 7, the example antenna array 2000 according to the present embodiment may include a plurality of first antennas 100 and a plurality of second antennas 200. The first antennas 100 and the second antennas 200 may be paired and disposed in pairs on the connection member 300, along the first direction DR1.

The first antennas 100 may transmit and receive RF signals of a first bandwidth, and the second antennas 200 may transmit and receive RF signals of a second bandwidth that is different from the first bandwidth. A center frequency of the first bandwidth may be lower than a center frequency of the second bandwidth. In a non-limiting example, the center frequency of the first bandwidth of the first antennas 100 may be about 24 GHz or about 29.5 GHz, and the center frequency of the second bandwidth of the second antennas 200 may be about 39 GHz.

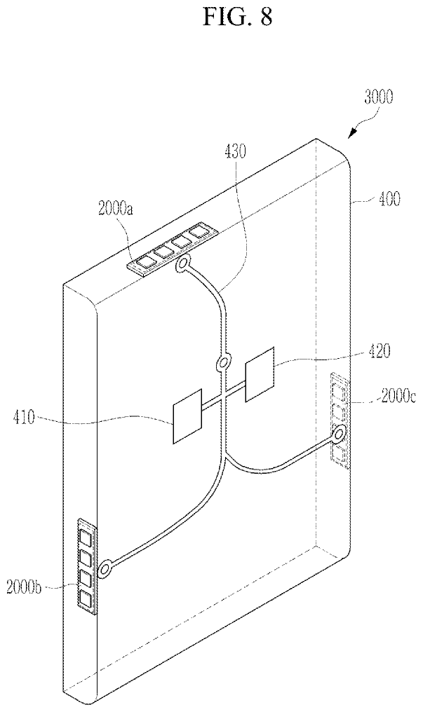

Hereinafter, an example electronic device 3000 including an antenna apparatus according to an embodiment will be briefly described with reference to FIG. 8. FIG. 8 illustrates a perspective view of an example electronic device 3000 including the example antenna apparatus, in accordance with one or more embodiments.

Referring to FIG. 8, the example electronic device 3000, in accordance with one or more embodiments, includes a plurality of antenna arrays 2000a, 2000b, and 2000c, and the antenna arrays 2000a, 2000b, and 2000c may be disposed on a set 400 of the electronic device 3000.

In an example, the example electronic device 3000 may be, as non-limiting examples, a smart phone, a personal digital assistant, a digital video camera, a digital still camera, a network system, a computer, a monitor, a tablet, a laptop, a network, a television, a video game, a smart watch, an automotive device, or the like, but the examples are not limited thereto.

The example electronic device 3000 may have polygonal sides, and the antenna arrays 2000a, 2000b, and 2000c may be disposed adjacent to at least some of the sides of the electronic device 3000.

A communication module or modem 410 and a baseband circuit 420 may be disposed in the example electronic device 3000, and the antenna arrays 2000a, 2000b, and 2000c may be connected to the communication module or modem 410 and the baseband circuit 420 through a coaxial cable 430.

The communication module or modem 410 may include at least one of a memory chip such as a volatile memory (e.g. a DRAM), a non-volatile memory (e.g. a ROM), a flash memory, etc., an application processor chip such as a central processor (e.g., a CPU), a graphics processor (e.g., a GPU), a digital signal processor, a cryptographic processor, a microprocessor, or a microcontroller, or a logic chip such as an analog-to-digital converter or an application-specific IC (ASIC), to perform digital signal processing.

The baseband circuit 420 may generate a base signal by performing analog-to-digital conversion, and amplification, filtering, and frequency conversion on the analog signal. A base signal inputted and outputted from the baseband circuit 420 may be transferred to the antenna apparatus through a cable. In an example, the base signal may be transferred to an IC through an electrical connection structure, a core via, and a wire, and the IC may convert the base signal into an RF signal of a millimeter wave (mmWave) band.

Although not illustrated, each of the antenna arrays 2000a, 2000b, and 2000c may include a plurality of antenna apparatuses 1000 and 1000a according to the embodiments described above, and may be similar to the antenna array 2000 described above.

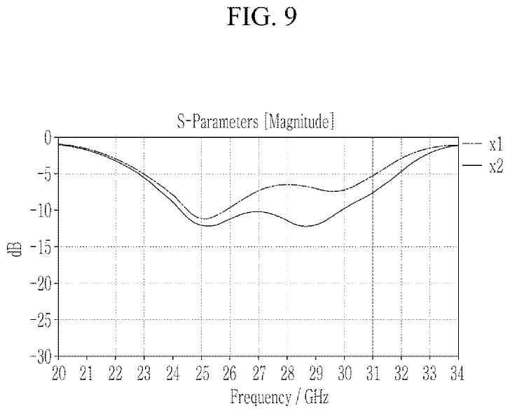

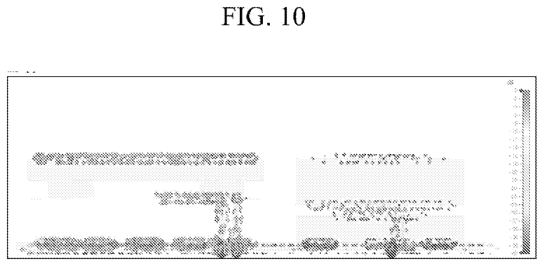

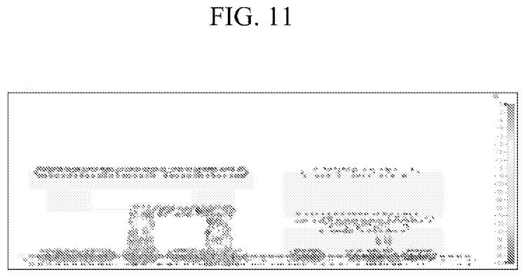

Hereinafter, an experimental example will be described with reference to FIG. 9 to FIG. 11. FIG. 9 illustrates a graph of a result of an experimental example, and FIG. 10 and FIG. 11 each illustrate a result of an experimental example.

In these experimental examples, other conditions are the same, but similar to a typical antenna apparatus, an S-parameter of the first RF signal of the first polarization was measured, and a result thereof was shown as a graph in FIG. 9, and distribution of a surface current of the antenna apparatus was measured and shown in FIG. 10 and FIG. 11 in a first example (x1) in which the first coupling via and the second coupling via were not formed, and in a second example (x2) in which the first coupling via and the second coupling via were formed as in the example antenna apparatus 1000, in accordance with one or more embodiments. FIG. 10 illustrates a result of the first example (x1), and FIG. 11 illustrates a result of the second example (x2).

Referring to FIG. 9, a frequency band in which a return loss of the first RF signal of the first polarization of the first example (x1) was −10 dB was about 24 GHz to about 26 GHz, but a frequency band in which the return loss of the first polarized first RF signal in the second example (x2) was −10 dB is from about 24.4 GHz to about 30 GHz, and in the second example (x2) in which the first coupling via and the second coupling via are formed as in the antenna apparatus 1000, in accordance with one or more embodiments, it can be seen that a bandwidth of the first RF signal of the first polarization is very wide.

Then, referring to FIG. 10 and FIG. 11, it can be seen that surface current distribution around a feed pattern is increased in the second example (x2) compared to the first example (x1). As such, compared to the first example (x1) for the typical antenna device, in the second example (x2) for the example antenna apparatus, in accordance with one or more embodiments, it can be seen that, in addition to coupling with the feed pattern connected to a feed via, additional resonance is generated by the coupling between the coupling via and the feed pattern and the feed via, thereby extending the bandwidth.

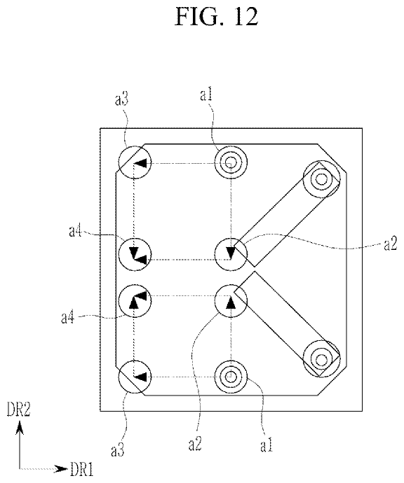

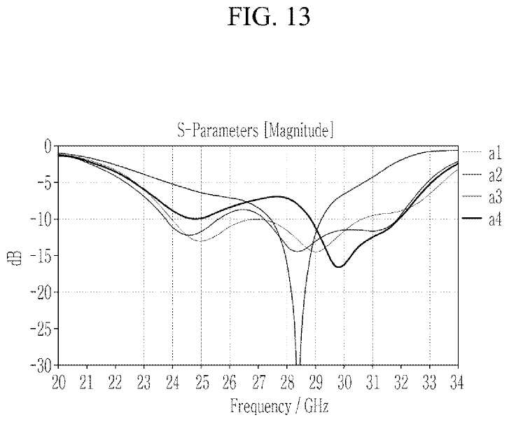

Hereinafter, an experimental example will be described with reference to FIG. 12 and FIG. 13. FIG. 12 illustrates a top plan view of an experimental example, and FIG. 13 illustrates a graph of a result of an experimental example.

In this experimental example, as illustrated in FIG. 12, a position of the first coupling via 131a is changed, the S-parameter of the first polarization first RF signal is measured for each example, and a result thereof is illustrated as a graph in FIG. 13.

Referring to FIG. 12, this experiment was carried out in a first example (a1) where the first patch antenna pattern 141 was formed to have a first width W1 of about 2.2 mm and a second width W2 of about 2.3 mm, and the first coupling via 131a was formed such that the first position P1, where the virtual first line L1 passing through the center C of the first patch antenna pattern 141 and parallel to the second direction DR2 is intersected with the first edge E1 parallel to the first direction DR1 and adjacent to the first feed via 111a among edges of the first patch antenna pattern 141, and an edge of the first coupling via 131a overlap each other; a second example (a2) where the first coupling via 131a was formed at a position moved about 0.5 mm toward the center C of the first patch antenna pattern 141 along a direction parallel to the second direction DR2 from the first example (a1); a third example where the first coupling via 131a was formed at a position moved by about 0.9 mm in a direction away from the first feed via 111a along a direction parallel to the first direction DR1 from the first example (a1); and a fourth example (a4) in which the first coupling via 131a was formed at a position moved by about 0.9 mm away from the first feed via 111a along the direction parallel to the first direction DR1 and moved by about 0.5 mm toward the center C of the first patch antenna pattern 141 along the direction parallel to the second direction DR2 from the first case (a1).

Referring to FIG. 13, it can be seen that, in the first example (a1), a frequency band in which return loss is −10 dB has a widest bandwidth of the first RF signal of the first polarization from about 24 GHz to about 30 GHz, in the third example (a3), the return loss is greater than −10 dB from about 26 GHz to about 27 GHz so that the bandwidth of the first RF signal of the first polarization is reduced, and in the second example (a2) and the fourth example (a4), the frequency band in which the return loss is −10 dB is relatively narrower.

As such, it can be seen that the bandwidth of the first RF signal of the first polarization is further reduced in the case of moving in the second direction DR2 compared to the case of moving in the first direction DR1 in the first case (a1).

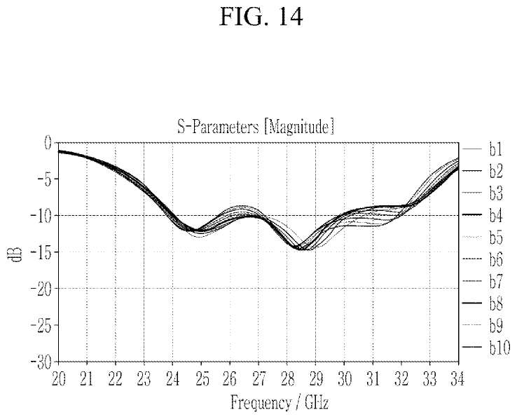

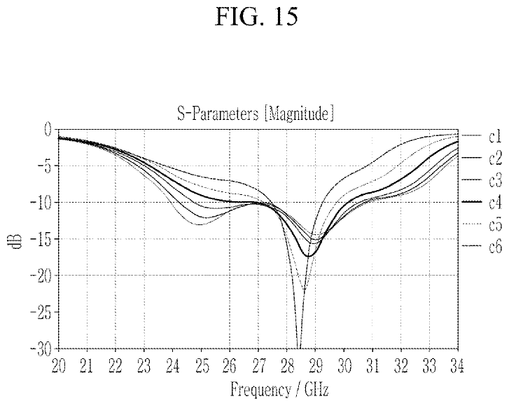

Then, a result of the S-parameter of the first RF signal of the first polarization depending on a change in a position of the first coupling via 131a will be described with reference to FIG. 14 and FIG. 15.

In this experimental example, in an example (b1) where the first width W1 of the first patch antenna pattern 141 is about 2.2 mm, the second width W2 of the first patch antenna pattern 141 is formed to be about 2.3 mm, and the first coupling via 131a is formed at a same position as in the first example (a1), results of the S-parameter of the first RF signal of the first polarization for examples (b2, b3, b4, b5, b6, b7, b8, b9, and b10) in which the first coupling via 131a is formed at a position gradually moved by 0.1 mm away from the feed via 111a along a direction parallel to the first direction DR1 from a position of the case (b1) are shown in FIG. 14. Additionally, in the present experimental example, results of the S-parameter of the first RF signal of the first polarization for cases (c2, c3, c4, c5, and c6) where the first coupling via 131a is formed at a position gradually moved by 0.1 mm toward the center C of the first patch antenna pattern 141 along a direction parallel to the second direction DR2 from a position of an example (c1) in which the first coupling via 131a is formed at a same position as in the first example (a1).

Referring to FIG. 14, it can be seen that, in the example (b1), a frequency band in which the return loss is −10 dB is wide, and compared to the example (b1), changes in values of the S-parameter of the examples (b2, b3, b4, b5, and b6) where a position of the coupling via is moved by about 0.1 mm, about 0.2 mm, about 0.3 mm, about 0.4 mm, and about 0.5 mm from the feed via along a direction parallel to the first direction DR1 are not significant, but changes in values of the S-parameter of the cases (b2, b3, b4, b5, and b6) where it is moved by about 0.6 mm, about 0.7 mm, about 0.8 mm, and about 0.9 mm are significant.

Referring to FIG. 15, it can be seen that, in the example (c1), a frequency band in which the return loss is −10 dB is wide, and compared to the example (c1), a change in a value of the S-parameter of the example (c2) where the position of the coupling via is moved by about 0.1 mm toward the center of the patch antenna pattern in a direction parallel to the second direction DR2 is not significant, but changes in values of the S-parameter of the examples (c3, c4, c5, and c6) where it is moved by about 0.2 mm, about 0.3 mm, about 0.4 mm, and about 0.5 mm are significant.

Accordingly, similar to the antenna apparatus according to the present embodiment, it can be seen that a frequency band in which the return loss is −10 dB is wide in the example where the coupling via is disposed to overlap the first area AR1 of the first patch antenna pattern 141, which is spaced within about 0.26 times the first width W1 of the first patch antenna pattern 141 and spaced within 0 mm to about 0.5 mm in the direction away from the first feed via 111a along the direction parallel to the first direction DR1 and spaced within about 0.07 times the second width W2 of the first patch antenna pattern 141, spaced within 0 mm to about 0.1 mm in the direction closer to the center of the first patch antenna pattern 141 along the direction parallel to the second direction DR2 from the first position P1 where the virtual first line L1 passing through the center C of the first patch antenna pattern 141 and parallel to the second direction DR2 is intersected with the first edge E1 parallel to the first direction DR1 and adjacent to the first feed via 111a among edges of the first patch antenna pattern 141.

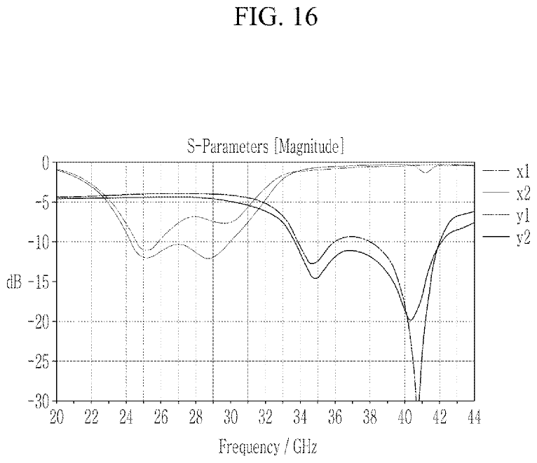

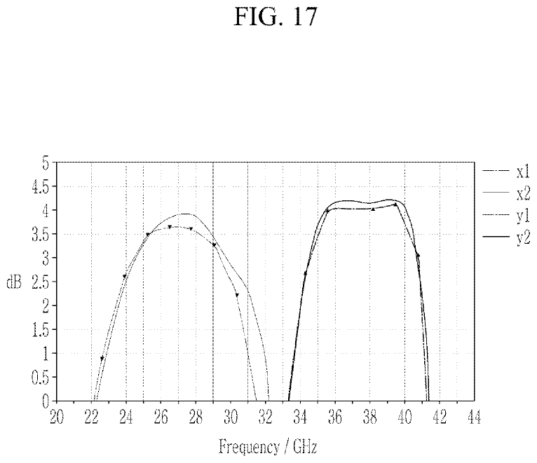

Hereinafter, another experimental example will be described with reference to FIG. 16 and FIG. 17. FIG. 16 and FIG. 17 each illustrate a graph showing a result of another experimental example.

In this experimental example, other conditions are the same, but similar to a typical antenna apparatus, S-parameters of a first RF signal of the first example antenna 100 and a second RF signal of the second example antenna 200 and results of measuring a gain of the first example antenna 100 and a gain of the second example antenna 200 were graphically shown in FIG. 16 and FIG. 17 in a first example (xl and xl) in which a first coupling via and a second coupling via were not formed and in a second example (x2 and x2) in which the first coupling via and the second coupling via were formed as in the example antenna apparatus 1000 according to the embodiment.

In FIG. 16 and FIG. 17, the results of the first antenna 100 are illustrated as x1 and x2, and the results of the second antenna 200 are shown as y1 and y2.

Referring to FIG. 16, a frequency band in which a return loss of the first RF signal of the first polarization of the second example (x2 and y2) where the first coupling via and the second coupling via are formed as in the example antenna device 1000 according to the embodiment was −10 dB is from about 24.4 GHz to about 30 GHz, and it can be seen that the bandwidth of the RF signal may be very wide compared to the first example (x1). Additionally, a frequency band in which the return loss of the second RF signal of the second antenna 200 was −10 dB is about 33 GHz to about 42 GHz, and it can be seen that the bandwidth of the RF signal is very wide compared to the first example (y1). In particular, it can be seen that, in the range of about 36 GHz to about 38 GHz, the return loss in the first example (y1) is increased by −10 dB, but the return loss in the second example (y2) was decreased by −10 dB. Accordingly, in the second example (x2 and y2) in which the first coupling via and the second coupling via are formed in the first example antenna 100, the bandwidth of the second example antenna 200 as well as the first example antenna 100 increases together.

Referring to FIG. 17, in the second example (x2 and y2) in which the first coupling via and the second coupling via are formed as in the antenna apparatus 1000 according to the embodiment, it can be seen that gains of the signals of the first antenna 100 and the second antenna 200 are increased compared to the first example (xl and yl) in which the first coupling via and the second coupling via are not formed. Accordingly, in the second example (x2 and y2) in which the first coupling via and the second coupling via are formed in the first example antenna 100, the gain of the second example antenna 200 as well as the first example antenna 100 increase together.

In accordance with the antenna apparatus according to the one or more examples, a multi-band antenna may be disposed in a narrow area, and a gain of an antenna to transmit and receive signals of different bands may be increased.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An antenna apparatus, comprising:
a ground plane;
a first dielectric layer disposed on the ground plane;
a second dielectric layer disposed above the first dielectric layer;
a feed via which extends through the first dielectric layer;
a feed pattern, disposed on the first dielectric layer, and connected to the feed via;
a coupling via which extends through the first dielectric layer; and
a patch antenna pattern disposed on the second dielectric layer,
wherein the coupling via overlaps, and is spaced apart from, the patch antenna pattern along a first direction from the ground plane toward the patch antenna pattern.

2. The antenna apparatus of claim 1, wherein:
the coupling via is connected to the ground plane.

3. The antenna apparatus of claim 2, wherein:
a height of the coupling via measured along the first direction is substantially equal to a height of the feed via.

4. The antenna apparatus of claim 3, wherein:
a center of the coupling via, a center of the feed via, and a center of an end a predetermined distance from the feed via among opposite ends of the feed pattern are disposed to form a substantially acute triangle on a plane viewed from a position above the first dielectric layer.

5. The antenna apparatus of claim 4, wherein:
the patch antenna pattern is disposed on a plane in which a second direction and a third direction perpendicular to the first direction intersect, and
the coupling via is disposed to overlap a first area of the patch antenna pattern that is formed by a first position where a first line passing through a center of the patch antenna pattern and parallel to the third direction is intersected with a first edge adjacent to the feed via among edges of the patch antenna pattern and parallel to the second direction, a second position spaced apart from the first position by a first distance away from the feed via in a direction parallel to the second direction, a third position spaced apart from the first position by a second distance closer to the center of the patch antenna pattern in a direction parallel to the third direction, and a fourth position spaced apart by the first distance in the direction parallel to the second direction and spaced apart by the second distance in the direction parallel to the third direction from the first position.

6. The antenna apparatus of claim 5, wherein:
the first distance is approximately 0.26 times a first width of the patch antenna pattern measured in a direction passing through the center of the patch antenna pattern and parallel to the second direction.

7. The antenna apparatus of claim 6, wherein:
the second distance is approximately 0.07 times a second width of the patch antenna pattern measured in a direction passing through the center of the patch antenna pattern and parallel to the third direction.

8. The antenna apparatus of claim 1, further comprising:
a third dielectric layer disposed between the first dielectric layer and the second dielectric layer.

9. The antenna apparatus of claim 8, wherein:
a dielectric constant of the third dielectric layer is less than a dielectric constant of the first dielectric layer and a dielectric constant of the second dielectric layer, and the third dielectric layer is configured to have an adhesive property.

10. The antenna apparatus of claim 9, wherein:
the feed pattern is disposed between the first dielectric layer and the second dielectric layer.

11. An antenna apparatus comprising:
a ground plane which extends in a first direction and a second direction; and
a first antenna and a second antenna disposed on the ground plane and spaced apart from each other in the first direction,
wherein the first antenna comprises a first feed via, a coupling via connected to the ground plane, and a first patch antenna pattern which overlaps the first feed via and the coupling via in a third direction, and
wherein the second antenna comprises a second feed via and a second patch antenna pattern which overlaps the second feed via.

12. The antenna apparatus of claim 11, wherein:
a height of the coupling via measured along the third direction is substantially equal to a height of the first feed via, and
the coupling via is spaced apart from the first patch antenna pattern.

13. The antenna apparatus of claim 12, further comprising:
a feed pattern coupled to the first feed via and coupled to the first patch antenna pattern.

14. The antenna apparatus of claim 13, wherein:
the feed pattern overlaps the first patch antenna pattern along the third direction and is spaced apart from the first patch antenna pattern.

15. The antenna apparatus of claim 13, wherein:
a center of the coupling via, a center of the first feed via, and a center of an end a predetermined distance from the first feed via among opposite ends of the feed pattern are disposed to form a substantially acute triangle on a plane viewed from a position above the first patch antenna pattern.

16. The antenna apparatus of claim 15, wherein
the coupling via is disposed to overlap a first area of the first patch antenna pattern that is formed by a first position where a first line passing through a center of the first patch antenna pattern and parallel to the second direction is intersected with a first edge adjacent to the first feed via among edges of the first patch antenna pattern and parallel to the first direction, a second position spaced apart from the first position by a first distance away from the first feed via in a direction parallel to the first direction, a third position spaced apart from the first position by a second distance closer to the center of the first patch antenna pattern in a direction parallel to the second direction, and a fourth position spaced apart by the first distance in the direction parallel to the first direction and spaced apart by the second distance in the direction parallel to the second direction from the first position.

17. The antenna apparatus of claim 16, wherein:
the first distance is approximately 0.26 times a first width of the first patch antenna pattern measured in a direction passing through the center of the first patch antenna pattern and parallel to the first direction.

18. The antenna apparatus of claim 17, wherein:
the second distance is approximately 0.07 times a second width of the first patch antenna pattern measured in a direction passing through the center of the patch antenna pattern and parallel to the second direction.

19. The antenna apparatus of claim 11, wherein:
the first antenna is configured to transmit and receive a radio frequency (RF) signal of a first band, and the second antenna is configured to transmit and receive an RF signal of a second band, and
a center frequency of the first band is lower than a center frequency of the second band.

20. The antenna apparatus of claim 11, wherein:
the first antenna comprises a first dielectric layer disposed on the ground plane, a second dielectric layer disposed above the first dielectric layer, and a third dielectric layer disposed between the first dielectric layer and the second dielectric layer,
the second antenna comprises a fourth dielectric layer disposed on the ground plane, a fifth dielectric layer disposed above the fourth dielectric layer, and a sixth dielectric layer disposed between the fourth dielectric layer and the fifth dielectric layer,
a dielectric constant of the third dielectric layer is less than a dielectric constant of the first dielectric layer and a dielectric constant of the second dielectric layer, and
a dielectric constant of the sixth dielectric layer is less than a dielectric constant of the fourth dielectric layer and a dielectric constant of the fifth dielectric layer.
